(19) United States
(12) Patent Application Publication
(10) Pub. No.: US 2007/0061125 A1
(43) Pub. Date: Mar. 15, 2007

(54) Enterprise environment analysis

(76) Inventors: Sandeep N. Bhatt, Madison, NJ (US); William G. Horne, Lawrenceville, NJ (US); Joseph N. Pato, Lexington, MA (US); Siva Raj Rajagopalan, Morris Plans, NJ (US); Prasad V. Rao, Edison, NJ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,014

(22) Filed: Oct. 31, 2005

Related U.S. Application Data
(60) Provisional application No. 60/707,677, filed on Aug. 12, 2005.

(51) Int. Cl. G06F 9/44

(52) U.S. Cl. 703/20; 703/23

(57) ABSTRACT

Embodiments of the present disclosure provide systems and methods for analyzing an enterprise environment. Briefly described, one embodiment of the system for analyzing an enterprise environment comprises a modeling module that determines possible accesses to enterprise network services from a plurality of entities; and a validation module that determines whether a possible access to an enterprise service by a particular entity violates an enterprise policy, the enterprise policy governing which entities are authorized to access one or more enterprise services.

### CROSS-REFERENCE TO RELATED APPLICATION

This application claims priority to copending U.S. provisional application entitled, “Model-Based Validation of Enterprise Access Policies,” having Ser. No. 60/707,677, filed Aug. 12, 2005, which is entirely incorporated herein by reference.

### TECHNICAL FIELD

The present disclosure is generally related to network architecture and, more particularly, is related to evaluating network architecture and settings.

### BACKGROUND

One objective of corporations is to ensure that important or sensitive information does not fall into the wrong hands. However, enterprise information technology (IT) environments are very complex with hundreds of thousands of people potentially working and interacting in this environment. Thus, the requirements on IT change constantly. These changing requirements are addressed by administrators changing configurations and access control settings to support new IT requirements. These changes are designed manually and as a result are slow and error-prone. Further, modern enterprise environments are a highly non-homogeneous mixture of components (hardware as well as software) that makes it hard to figure out who has access to what resources across the enterprise either directly or indirectly through a chain of components.

One problem in modern enterprises is managing security under dynamic conditions. A fundamental issue in solving this problem is that enterprises deploy multiple access control mechanisms at different technology layers. Each mechanism is painstakingly configured and maintained using legacy user interfaces, most likely by different administrators in different organizations at different sites, perhaps employing different notions of users and roles. A core technical hurdle is that the complexity and scale of multiple functions and their interactions across the environment makes it hard for humans to disentangle the various functionalities.

Thus, a heretofore unaddressed need exists in the industry to address the aforementioned deficiencies and inadequacies.

### SUMMARY

Embodiments of the present disclosure provide systems and methods for analyzing an enterprise environment. Briefly described, one embodiment of the system, among others, can be implemented as follows. A system for analyzing an enterprise environment comprises a modeling module that determines possible accesses to enterprise network services from a plurality of entities; and a validation module that determines whether a possible access to an enterprise service by a particular entity violates an enterprise policy, the enterprise policy governing which entities are authorized to access one or more enterprise services.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of one embodiment of an enterprise environment analysis system of the present disclosure.

FIG. 2 is a flow chart describing functionality of one embodiment of the system of FIG. 1.

FIG. 3 is a flow chart describing a self-securing process implemented by one embodiment of the system of FIG. 1.

FIGS. 4-5 are flow charts describing embodiments of methods of automating the security of an enterprise system utilizing the system of FIG. 1.

FIG. 6 is a block diagram of an enterprise environment used as a subject of the system of FIG. 1.

FIG. 7 is a block diagram of a computer system implementing functionality involved in the system of FIG. 1.

### DETAILED DESCRIPTION

In a large enterprise system, there is usually a number of administrators who control and configure a wide variety of components in response to changes in business requirements as well as component failures, upgrades, etc. making the enterprise very dynamic. In such environments, it is usually desirable that enterprise network policies be upheld at all times, such as through operator errors and outside attacks.

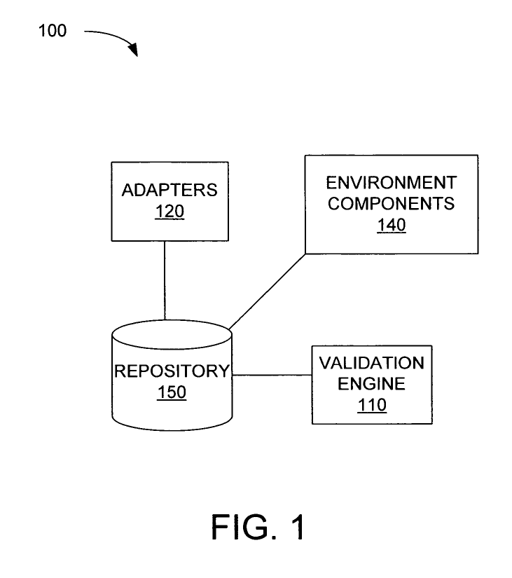

Accordingly, one embodiment of the present disclosure is an enterprise environment analysis system that performs an analysis of an enterprise system against enterprise policies. In one embodiment, components of the enterprise environment analysis system 100 are shown in FIG. 1. One component is a validation engine 110 that performs an analysis of an enterprise environment against specified policies. Based upon the analysis, the validation engine 110 may output a list of violation of enterprise policies. Further, one embodiment of the validation engine 110 also detects and reports violations (e.g., access to non-permitted services, whether direct or indirect) and suggests new configuration values to restore the enterprise to a policy-compliant state, when possible.

Policies may be specified as parameters or statements on accessibility of services to entities in the enterprise environment that are maintained in a repository 150. These statements are at a high-level appropriate for directly specifying the intent of the specifier without having to know the means by which the policies are enforced.

At the same time the policies are precise enough to be input into the validation engine 110 for validation. The entities could be from role and resource hierarchies or could be more general. Policies capture both positive and negative requirements. Meta-policies such as “default-deny” can also be stated for completeness.

### Environment Components and Assets

An environment, such as an enterprise environment, can be considered to be a collection of hardware components 140 (along with software components running on them) that are connected together in a specific way in a given network, such as an enterprise network. The environment which is being validated is described to the validation engine 110 in terms of an inventory list of the components that are found in the environment as well as the values of some or all of the configuration parameters or values that have been assigned to these components. Configuration values are the values of the settings of component instances in the environment. In the current context, these settings can be either from a real environment or from one that is being designed.

The enterprise environment analysis system 100 may also include adapters 120 that read and write configuration parameters from enterprise components, and translate these into a standard format for analysis. These adapters can be custom scripts, or interfaced with existing commercial asset and configuration management tools, for example the HP OpenView® suite, CiscoWorks®, etc.

Common environment components of interest include, but are not limited to, web servers, file servers, applications, host machines, databases, routers, and switches.

In one embodiment, a library of models for system components, as maintained in a repository 150, which define the behavior of each component as functions of their configuration parameters is provided.

From an executive perspective, an enterprise possesses information assets such as data on employees, customers, products, partners and suppliers, and applications that manipulate these assets in specific ways. Access to enterprise data depends on the identity and role assigned to the user, the method of access, and the action to be performed. For example, the enterprise security policy may stipulate that “users authenticated as employees may read and edit personal information via the HR self-service portal.” Another policy may state that “traders must be denied all access to analyst data.”

From the administrative perspective, an enterprise consists of components some of which store enterprise data and others host applications to access and manipulate the data. A component can represent a physical device such as a router or server; it can be an operating system, file system, database or other infrastructural software; or it can be application software such as a web application for example.

How a component is configured determines how it processes incoming requests, and which other components it interacts with. The configurations of individual components together specify overall system behavior; that is, configurations determine which users can access and manipulate specific data sets in specific ways. One crux of the administrative problem is to configure the components so that the system behavior matches the executive policies.

### An Illustrative Process

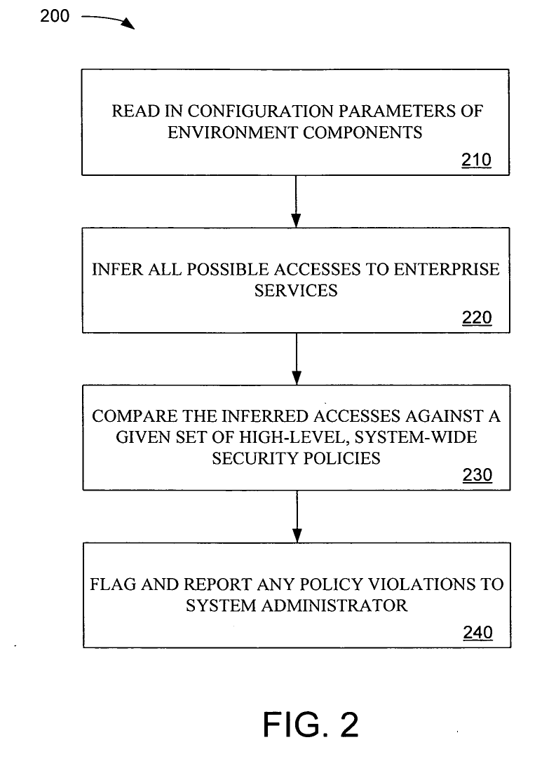

Referring now to FIG. 2, a flow chart describing functionality 200 of the enterprise environment analysis system 100 for one embodiment is shown. Starting with block 210, the process begins with reading in configuration parameters of environment components, where the configuration parameters are controlled by systems administrators. Then, component models infer (220) all possible accesses to enterprise services. Note that, within this context, component models are concise logical descriptions of the input-output message relationships of each component with other components. Next, the inferred accesses are compared (230) against a given set of high-level, system-wide security policies by the validation engine 110, where the security policies are positive and negative requirements for accessibility of services to enterprise entities, such as clients. The process continues with the step of flagging and reporting (240) any policy violations to system administrators.

### An Illustrative Process

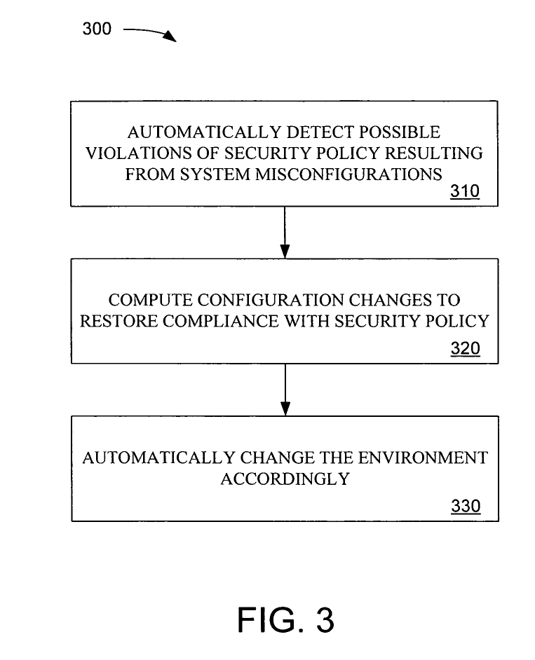

Referring now to FIG. 3, a flow chart describing a self-securing process implemented by one embodiment of the enterprise environment analysis system 100 of FIG. 1 is shown. This process 300 makes an enterprise environment self-securing in order to help plan and analyze configuration changes before they are deployed, and to audit live systems for access loopholes before any violations occur.

As such, the process 300 includes the step of automatically detecting possible violations (310) of security policy resulting from system misconfigurations and computing (320) configuration changes to restore compliance with security policy. As a result, the process automatically changes (330) the environment accordingly.

### Modeling

One innovative aspect of these approaches is the model-driven approach that is used to automate security access analysis. Models are built and used to capture the access control semantics of applications, middleware and devices, in a manner that enables efficient enterprise-scale analysis of the net effect of these control settings across the enterprise.

Models are descriptions of components found in the environment that capture the functional behavior of these entities. A model is associated with the type and version of the component. Models can be written at any level of granularity of choice. Models can be built hierarchically or otherwise. Models can be written of abstraction components (e.g. “generic firewall”) or a specific real component (e.g. CheckPoint Firewall® version 1.0 release 1). Models can be written for a component at any layer of the network stack.

A model of a component has two parts: configurational attributes and predicates. Configurational attributes are the various parameters that control the behavior of the component and the values they are allowed to take. Configurations of a real instance of a component are the specific attributes and values associated with that instance. A model writer may choose which attributes of the component to include. In one embodiment, only attributes that are relevant to security are included.

Predicates are logical statements that, given a configured instance of a component, can check that the instance is configured “correctly” and describe the functional behavior of the instance. A model may contain a disjunctive list of predicates and each predicate can depend on the values of the attribute values/configurations. The predicates model the abstract message interfaces supported by each component. Both best-case and worst-case behaviors are captured in separate predicates including the conditions on the configuration values of the component instance and dependencies on other components. In one embodiment, conservative approximations are used to simplify the models.

The models mentioned above are used by the validation engine 110 to perform validation. The validation engine 110 computes all possible services that are accessible end-to-end to any client machine or role by computing the transitive closure on all predicates that have been instantiated. Each path corresponds to a sequence of components along with the conditions that are necessary to make the overall access predicate true. The validation step checks that for each role and service that is covered by a positive policy there is at one access path for that role to that service. These access paths are collected in a “validation set.” If there are any permit policies that do not have at least one access path, these are reported as violations. For processing negative policies and meta-policies such as default-deny, all the access paths that either contradict negative policies or not necessary to make the positive policies true are reported as violations. In addition, the extra access paths are reported as “witnesses” of the violation. For processing negative policies, it is ensured that no indirect access to a non-permitted service can occur.

The model of a component instance along with its configuration value provides single-step reachability of services in this environment, where the validation engine 110 computes the closure of reachability of all services across all components in the environment.

### Design and Planning Interface

In one embodiment, a design and planning tool interface for enterprise configurations is also provided. Via the design and planning tool, a user can input configuration values and policies, either or both of which may be obtained from a real enterprise environment or a synthetic one. The design tool can then use the validation engine 110 mentioned above to verify that the proposed environment upholds security policies. Whenever there is a violation, the validation engine 110 detects it and provides an example violation.

By changing the configuration settings, policies, or both, the user can validate new environments without/before deploying them in reality via design and planning tool interface. The user can create synthetic environments for such testing purposes by changing existing configuration settings or policies in the given environment via design and planning tool interface.

### Diagnostic Interface

In addition, a trouble-shooting or diagnostic tool interface for enterprise services is also provided in one embodiment. A user (such as a system administrator) may use the trouble-shooting tool to compute all the services that are accessible to any particular entity in the enterprise or all the entities that can access a particular service. The user can also use the tool interface to compute the actual paths by which a particular service is made available to a client entity. The user can also query the effectiveness of access control lists at any particular component, i.e. given any access control rule, compute the access paths that this rule allows/blocks. The internal steps of the transitive closure that the validation engine 110 computes can be used to compute all these answers.

### An Illustrative Process

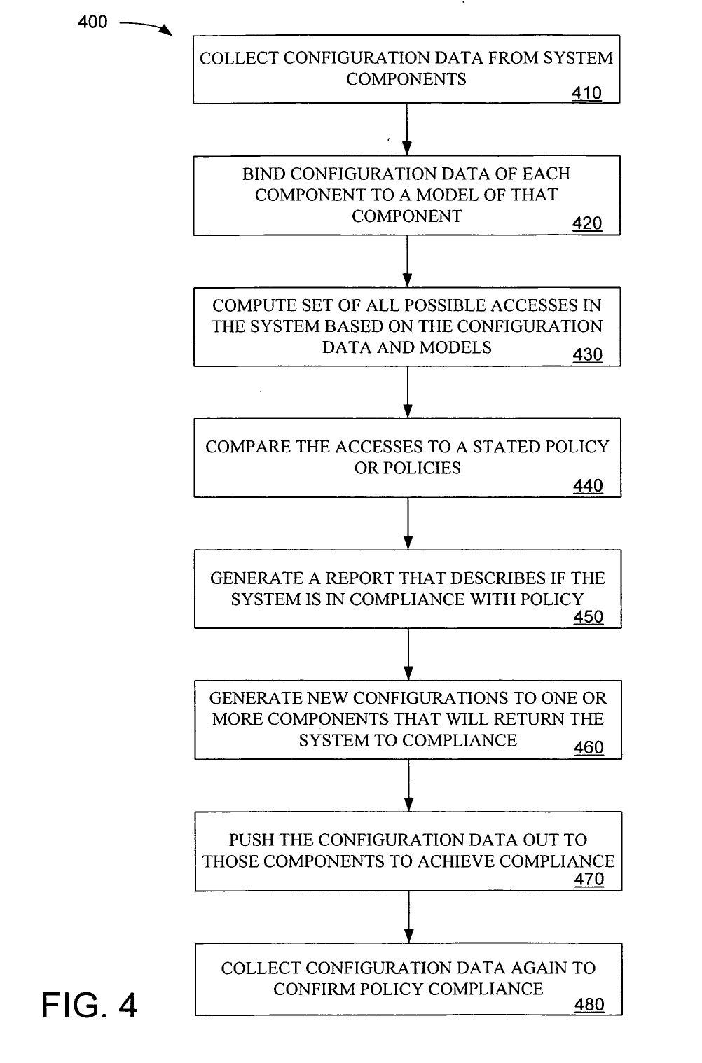

Referring now to FIG. 4, a flow chart describing one embodiment of a method 400 of automating the security of a system is described. In block 410, the step of collecting configuration data from system components is shown. Then, the configuration data of each component is bound (420) to a model of that component. Based on the configuration data and models, the set of all possible accesses in the system are computed (430). The accesses are then compared (440) to a stated policy or policies. Next, a report is generated (450) that describes if the system is in compliance with policy. Accordingly, new configurations to one or more components may be generated (460) that will return the system to compliance, and the configuration data is then pushed (470) out to those components to achieve compliance. Afterwards, configuration data is collected again to confirm (480) policy compliance. If compliance is not confirmed, then the process is repeated.

With the approach outlined in FIG. 4, the previously discussed framework may be extended, in one embodiment, to include (i) the capability to generate new configurations to restore compliance when policy violations are found, (ii) the capability to accept data, if it exists, on hitherto unknown vulnerabilities in any existing component or components and assessing whether these vulnerabilities can lead to policy violations, and (iii) the capability to push the new configurations into the enterprise environment so that it can be restored to policy compliance.

For example, whenever a policy violation is detected in a positive policy, one embodiment of the enterprise environment analysis system 100 sequentially traverse all paths from each client (which is attached to that role) to each server in the service set up to the component where access is blocked. For this component, the enterprise environment analysis system 100 generates a new configuration that extends at least one path for that role and server and proceed to the next component.

When there is a path from the client to the server, one embodiment of the enterprise environment analysis system 100 performs the validation step on the enterprise environment to check if new violations are created and if so, the enterprise environment analysis system 100 abandons this path and try the next one. Thus, the enterprise environment analysis system 100 ensures that new configurations do not cause violations to other policies. Analogously, to address negative policy violation paths, one embodiment of the enterprise environment analysis system 100 changes the configuration on a component to block the access to the requisite role and service that would remove the violation on each path. The enterprise environment analysis system 100 then revalidates the entire configuration. If new policy violations are created, the enterprise environment analysis system 100 tries the next component on the path iteratively. If no component can be found to successfully block access, the enterprise environment analysis system 100 declares that the deny policy is not enforceable. With optional administrator approval, the new configurations are sent to the control infrastructure to be deployed. After waiting a requisite period of time, the enterprise environment analysis system 100 collects configuration data again and revalidates. If no violations are found, one embodiment of the enterprise environment analysis system 100 stops. If not, the enterprise environment analysis system 100 repeats the configuration generation process. The sequence of data collection, policy validation, configuration generation (if necessary), and configuration deployment (if necessary) are repeated with some periodicity. The time period is a parameter chosen by the administrator.

### An Illustrative Process

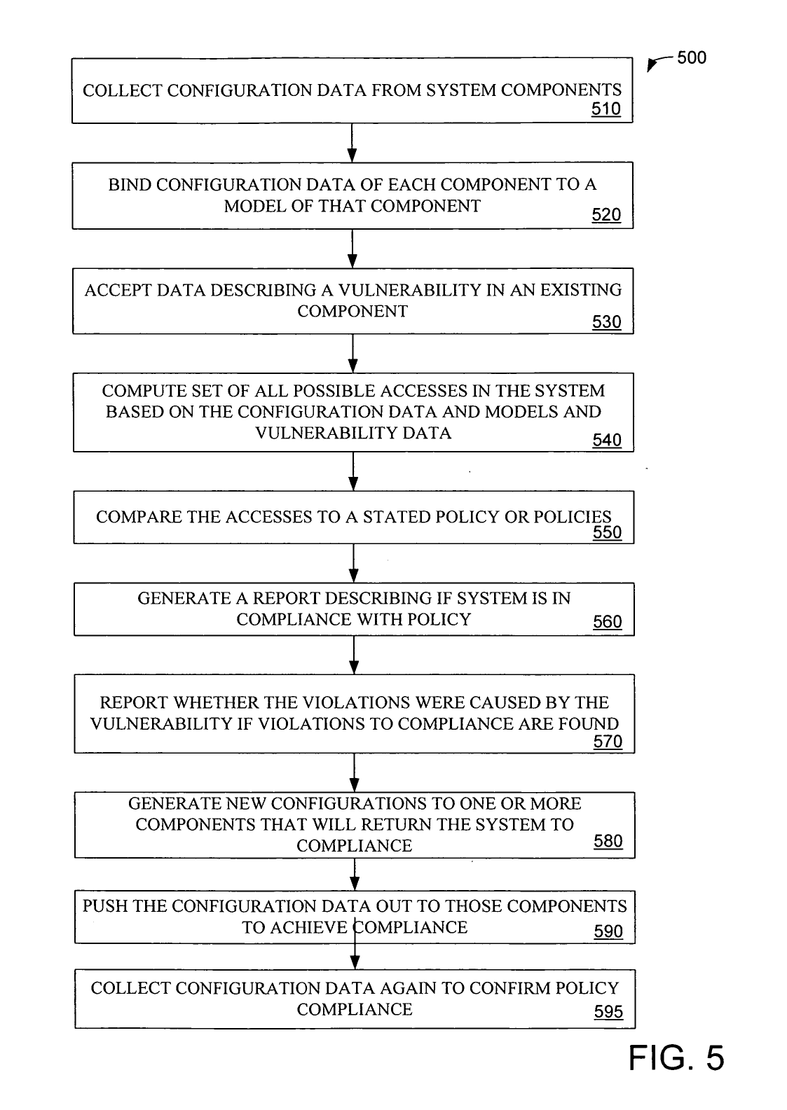

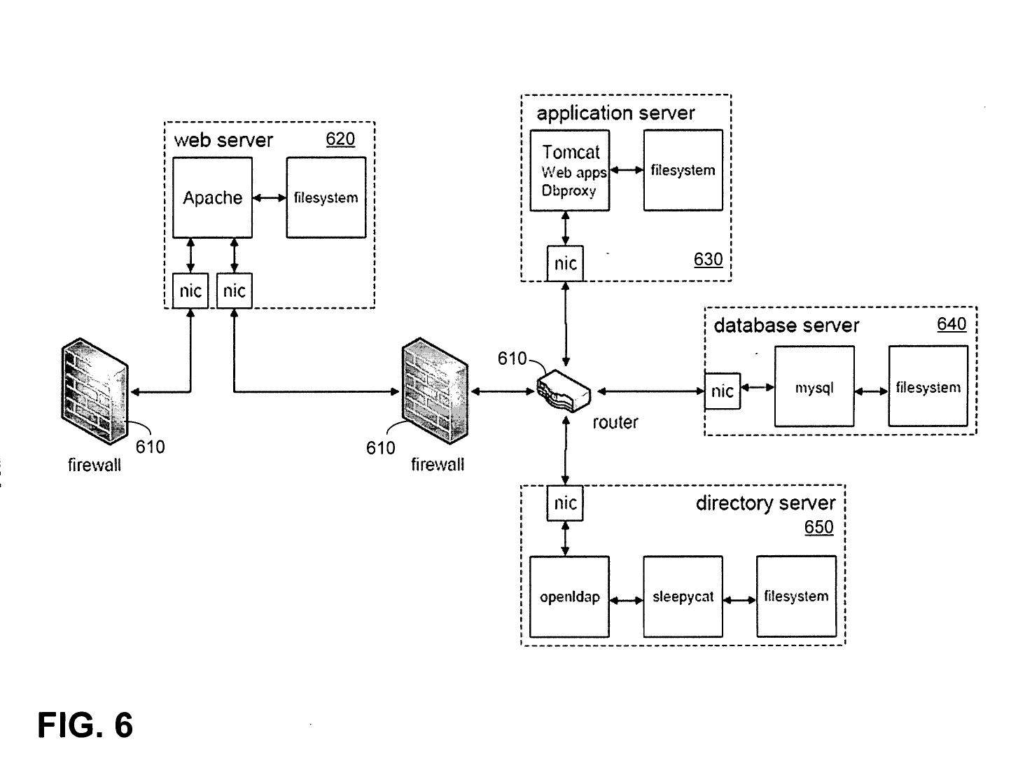

Referring now to FIG. 5, a flow chart describing one embodiment of a method 500 of automating the security of a system is described. The method begins at step 510 with the collection of configuration data from system components, where the configuration data of each component is bound (520) to a model of that component. Next, data describing a vulnerability in an existing component is accepted (530). Based on the configuration data and models and vulnerability data, the set of all possible accesses in the system are computed (540). The accesses are then compared (550) to a stated policy or policies. Afterwards, a report is generated (560) describing if system is in compliance with policy. If violations to compliance are found, whether the violations were caused by the vulnerability is reported (570). Further, new configurations to one or more components are generated (580) that will return the system to compliance. Accordingly, the configuration data is pushed (590) out to those components to achieve compliance. Then, configuration data is collected (595) again to confirm policy compliance. If compliance is not achieved, then the process repeats.

### Updating of Models

For some embodiments, when a new vulnerability is reported in a component, this entails changing the model for that component. The change in the model reflects the new mode of access to services that the vulnerability represents. In the case where the new access is unknown, one embodiment of the enterprise environment analysis system 100 uses a conservative approximation to reflect the vulnerability. The updated model is then used in place of the regular model for that component. This step may be repeated for each component with a reported vulnerability.

Similarly if a component is upgraded or modified the model for that component is changed to reflect the change in the component in a similar way as above. The configuration collection and reasoning steps are taken exactly as before and any new violations that are detected as a result are reported. The configuration generation step proceeds as above. The vulnerability alert or the component change notification and model change may be automated in themselves so that the automation of security policy management includes reaction to these kinds of changes.

### An Illustrative Implementation Utilizing Modeling Languages

Next, a possible example of an implementation is presented. Many variations and modifications may be made to the example without departing from the principles of the present disclosure.

Suppose that an embodiment of the enterprise environment analysis system 100 is given for all the configuration values of all the entities in an enterprise. The validation engine 110 attempts to generally answer questions of the form: “will requests from client C to entity E to perform operation O with arguments A succeed, or will the request be denied?” To answer this question, the validation engine 110 logically simulates the actions of entity E (e.g., perhaps it first authenticates client C against an LDAP (lightweight directory access protocol) server it is configured to query; next, it checks to see if its own access controls allow user C to perform the requested operation; if so, it may send, as user E, requests to other components to perform ancillary operations; if all entities thus encountered are configured to allow the spawned operations to succeed, the request can succeed. On the other hand, if any request along the way is blocked, it may be that the request cannot succeed for the given configuration.)

Therefore, the analysis performed by the validation engine 110 is characterized by the following, in one embodiment. First, the analysis is memoryless: the set of allowed operations in any snapshot depends on the configuration state at that point in time, but not on the temporal history of the system. In addition, the analysis is static. The assumption is that the configuration values represent a snapshot of the system at one point in time. The analysis indicates who can access what services at this point in time. The validation engine 110 does not analyze sequences of events and state transitions over time. Instead, the analysis can be conducted periodically, using different snapshots of the system in time. Further, the analysis is restricted to security “holes” created by inconsistent or mistaken configurations that can be exploited by an honest-but-curious adversary. Such an adversary seeks to gain access to services that are prohibited to him by high-level policy, but which the system configuration does not correctly enforce.

For each entity, models are created that operate as follows. Given a specific type of request, the model of a component describes all the possible information flows through that component as a function of its configuration parameters. For example, for a given input request type (perhaps a user name and password), the model indicates if the component checks whether the client has permission to access the service, and if so, which other components might it invoke to process the request (for example, which LDAP server it queries to authenticate the client and obtain its role), and whether it sends a reply back to the client.

For security analysis, the models may be conservative. For example, in one embodiment, if the model indicates that a user request is blocked, then it should not succeed in the real system with the same set of configurations, but the converse may not always be true. Also, note that when each model is conservative in capturing the outcome for all possible information flows—that is, all responses for every request and every assignment of values to the configuration parameters—then the analysis over a set of models representing an enterprise is also conservative.

Often, a component may have dozens of parameters that can be configured by an administrator to affect behavior. This includes machine settings, operating system parameters, and application specific settings. Parameters that are not of interest within the enterprise environment analysis system 100 are those that determine performance but do not change possible information flows, such as cache sizes or timeout values (unless some value for these is guaranteed to block all requests).

Examples of configurations that do affect the flow of information are access control rules (on routers, firewalls, file systems, data bases, web servers, etc.) and component-specific parameters such as skip-networking and skip-grants-tables. An additional consideration is that configuration parameters of interest remain under administrator control and change infrequently relative to program variables which change dynamically and automatically during program execution.

The computational complexity of the analysis is determined by the representations chosen for the models and the expressive power of the modeling language. The greater the expressive power, the easier it is to formulate models for entity behavior, but the greater be the complexity of performing the analysis.

In one embodiment, models are represented as predicates, defined by Prolog rules, but restricted to use a subset of Prolog called Datalog. This restriction is key, since datalog complexity is polynomial time. In particular, there are several systems that evaluate datalog programs very efficiently, and that scale to large problem instances. In one embodiment, the XSB Prolog engine [XSB] is used to evaluate datalog programs in a bottom-up manner and employ tabling to store intermediate results, which allows for the tackling of enterprise-scale systems. An example implementation is now discussed.

Since enterprises contain entities of various types—firewalls, database servers, and file systems for example, each entity type has an associated model that specifies its information flow as a function of the configuration parameters of the entity type. For example, an enterprise can consist of a set E₁, . . . , Eₙ of configured entities, where a configured entity is an instance of an entity type with all its configuration parameters given concrete values. A request from a client C to a configured entity E is a pair O, A consisting of an operation and an argument. This request to E returns result R to C. R could either be an error (in case the request was blocked by an access control rule or else resulted in an error elsewhere), or, if E successfully processed the result, it is a value.

The predicate allows(E, C, O, A, R) is defined to to be true if and only if R is not an error. A service S is a subset of O x A. The service S_{E.C} provided by entity E to client C is defined to be the set {(O, A)|allows(E, C, O, A, R)}.

In this example, an enterprise access policy specifies who (by role) is allowed (alternatively, must be denied) access to what enterprise services. The key to policy-driven enterprise access management is to directly capture the high-level intent of the network and keep policy statements precise, simple, declarative, and free of implementation details. Declarative policies allow intent to be declared without tying them to specifics of network and application implementations, which are subject to change. Policy statements are written to be simple so that (i) it is easy to verify whether or not the system is compliant, and (ii) since humans specify policies, maintaining a set of policies is not unnecessarily complex. Indeed, allowing arbitrarily complex policies can make it intractable to reason about the net effect of a small policy set.

There are two basic types of access policy:

Permit(Client, Entity, Service), and

Deny(Client, Entity, Service).

A permit policy Permit(C, E, S) is satisfied when the service S_{E.C} provided by the configured system (set of requests for which the allows predicate for specified client and entity is true) is a superset of the service S specified in policy. In other words, every client permitted by policy to invoke a service on an entity must be able to do so by sending a request directly to the entity.

The semantics of a deny policy are somewhat different. A deny policy Deny(C,E,S) is satisfied if and only if there is no request that client C can invoke on any entity, which will, via a chain of requests, cause some client (perhaps a different one) to invoke a request in S on entity E. In other words, satisfying a deny policy rules out the possibility of transitive access via all possible sequences of steps, including those involving intermediate applications.

Note that, under the above definitions, a deny policy is stronger than the negation of a permit. A permit policy can be violated if the client cannot send a request to the service, or if a filter rule denies the client request, or if the service is unavailable because, for example, one of the subservices it depends on is down. On the other hand, to satisfy a deny policy, there must be explicit filter rules that block the client from, directly or indirectly, sending the request to the service. As an example, consider a web server which provides “audited web access”—this service depends on the web server to allow normal access, a logging process to log user requests and an auditing process to audit the logged requests. Say that the logging process is down. At this point, a permit policy on the audited service is violated, even though the web server may process user requests and serve HTML pages. For a similar deny policy on the audited service, it would be awkward to claim that the deny policy is satisfied if a client can access the web pages without the requests even being logged. Therefore, a solution would be to block requests so that they cannot invoke any actions at all.

The set of access policies for an enterprise are assumed to be specified in order of priority. For example, the deny policy deny(client, file_system, read, file_name) blocks all requests from a client which can eventually result in a specific file being read. But suppose the client prefers to be able to access the file via the web server. In this case, the more specific policy permit(client, web_server, get_http, url) should be listed before the more general deny. The task of the system will then be to set the access controls so that the web access is permitted, but all other access routes to the file are blocked.

Note that any service that is not explicitly permitted by policy should be denied, unless it is required to support a higher-priority permit policy. In other words, the principle of least privilege which specifies that a user should only get access to those services that are needed to support the enterprise policy and nothing more is followed. Finally, note that default deny does not obviate the need for explicit deny policies. For example, if all but a subset of clients access to a service is desired to be permitted, the straightforward solution is to write a specific deny policy for the subset, followed by a more general allow policy for all clients.

In this example, models are specified using three predicates: attributes, allows, and triggers. The first predicate, attributes, is used to specify the names and types of all configuration parameters of the entity. The second predicate, allows, captures the set of possible conditions under which the entity will respond to a client request with a specific result. These conditions are a function of the configuration parameters of the entity and those it interacts with, as well as certain uninterpreted variable that represent request parameters (such as client information and arguments, for example). The third predicate, triggers, models the conditions under which one request to an entity can lead to subsequent requests by the entity to other entities.

In one embodiment, each predicate is defined using a number of rules, in the style of Prolog. The semantics is that the predicate is true when at least one of the rules evaluates to true. When some of the arguments remain uninterpreted, the condition for the predicate to be true is simply the OR of the conditions for each of the rules to evaluate to true.

In one embodiment, attributes are specified in the form:

attributes(entityName, [attrtype(attributeName, attributeType, defaultValue)]), where entityName is the entity being modeled, and the second argument is a list of attribute name, value pairs (default values are optional). A type is either a standard type, such as integer, string, etc., or the name of another attribute. This enables complex attributes such as a list consisting of access control rules to be defined. Such attributes can be viewed as extensional predicates of the models. For example, if the attribute isAuthorized is defined to be a list of triples, then the predicate isAuthorized(x,y,z) is true if and only if the triple (x,y,z) appears in the corresponding list.

The predicate allows(E, C, O, A, R) is true if and only if the request O, A from C to a configured instance E succeeds with result R returned to the client. Each predicate should be defined to cover all types of clients and requests that are modeled. For example, if an entity responds to client identified by any combination of host name, userid, and credential (password, token or cookie) then the “allows” predicate should be defined over all combinations, using multiple rules as necessary. The conditions which appear on the right side of a rule contain configuration parameters of the entity, which may be simple attribute values or may be a table (an access control list for example). The right side may also contain variables that are uninterpreted, for example, client attributes or credentials, or arguments to an operation.

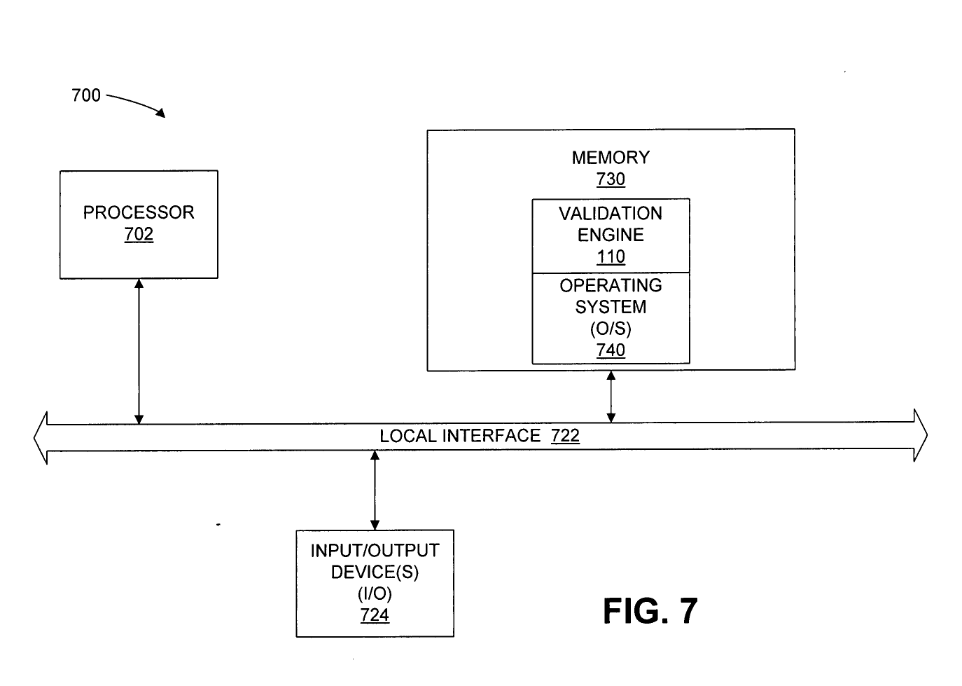

As an example, consider the following fragment from the model of a MySql server in the following 3-tier web site architecture, as shown in FIG. 7, comprising a perimeter firewall 710 protecting an Apache web server 720, a Tomcat servelet container 730 to host web applications, a backend MySql database server 740, an LDAP server 750, and router 760. A large number of configuration parameters restrict information flow in this simplified example:
1. The perimeter firewall rules determine whether the client request will reach the machine hosting the Apache server 720. Note that firewall filter rules are viewed as configuration parameters, in this example. While the common parlance for these access control rules is “policy,” the term policy is used sparingly to refer only to global, enterprise-wide invariants that must be satisfied. It is not used to refer to specific rule sets on devices and applications.
2. Apache server configurations will determine if, and where, the user credentials are checked.
3. If the Apache server 720 is configured to use the LDAP server 750, then LDAP directory data are used to map users to roles.
4. Apache mapping rule configurations examine LDAP specified role information to determine where the request is forwarded, and with what credentials.
5. Tomcat configurations determine if, and where, user credentials are checked, and which web applications and database proxies the request is allowed to invoke. The database proxies are configured with user names and passwords to establish connections to specific databases. Finally, Java security policy (Catalina.policy) configurations specify permissions granted to web applications for reading or writing to the file system, and opening socket connections, etc.
6. Web applications hosted on Tomcat may have their own notion of users, credentials, and use application specific filters to permit or deny requests, independent of Tomcat configurations. In general, unless these applications have exposed any configurable parameters, web applications are treated as black boxes.
7. MySql configurations determine if the server accepts network connections, and if it checks permissions for establishing connections and running queries. The privileges configured within the Mysql database tables determine whether specific queries are to be run or not.
8. Finally, the file system is configured with its own access control parameters.

In this case, the “allows” rule models when a dbconnect request (with no arguments) sent from a client (specified by hostname, usename and password) to the database instance MySql results in a connection(host,user) returned by MySql to the client. The body of the definition specifies the conditions under which the connection can be established. In particular, the rule depends on the values of the Mysql attributes. The predicate is_authorized is an extensional predicate corresponding to a table named is_authorized which is an attribute of the MySql model. Note that this definition only specifies what the database server 740 does when it receives one kind of request, namely a connection request. A complete specification of the database server 740 will include additional allows rule statements to cover all possible input request types. A set of allows rules are shown below.

| | allows(Mysql,dbclient(host,user,pwd),dbconnect,[ ],connection |
|---|---|
| | (host,user) |
| | :- |
| or | ( [ |
| | not attr(Mysql, max_connections, 0), |
| | host = localhost, |
| | or(attr(Mysql, skip_grant_tables, ON), |

is_authorized(Mysql,host,user,pwd))

],
[
not attr(Mysql, max_connections, 0),
not(host = localhost),
not attr(Mysql, skip_networking, ON),
or(attr(Mysql, skip_grant_tables, ON),

[is_authorized(Mysql,host,user,pwd),

or(is_ipaddr(host),

not attr(Mysql, skip_name_resolve, ON))

])
])

In general and for this example, the right-hand side of an “allows” rule can contain allow predicates on other entities. For example, the following rule from a model for an Apache web server 720 states that if the URL (uniform resource locator) requested corresponds to a jsp (java server page), and the Apache server 720 is configured to talk to a specific instance of a Tomcat server 730, then the request succeeds if the Tomcat server 730 successfully processes the request from Apache (running as Apache user). The result returned by Tomcat 730 is passed back to the client:

allows(client(machineID, IPaddr, credentials(user,password)), apacheI,
get, url, Result)
:-
attr(ApacheI, runAs, Me)
isJSP(url)
attr(ApacheI, jspserver, TomcatI)
allows(Me, TomcatI, jk2invoke, url, Result)

One observation to make is that all the “allows” terms in the body (the right side of a rule) appear positively—no “allows” term is negated. This is observed to be the case in a wide variety of entity models and enterprise scenarios. This may be because information flows are monotonic—enabling a new information flow does not disable existing enabled flows. Indeed, it is difficult to imagine cases where this is not the case.

When none of the “allows” is negated, the result is that the set of all allow rules form a datalog program. An important consequence is that, given all attribute values for all entities, the conditions under which each “allows” predicate is true can be efficiently evaluated. These conditions are expressed as propositions containing only uninterpreted variables, and equality checks and extensional predicates over the uninterpreted variables.

In principle, datalog programs can be evaluated in time polynomial in the size of the datalog program. In practice, bottom-up evaluation of rules combined with tabling of intermediate results is an efficient way to evaluate datalog programs. For example, the XSB Prolog engine uses this strategy and evaluates datalog programs efficiently in one embodiment.

An additional predicate is often useful to include in models of entities. The predicate captures the notion that a request made by an entity can be triggered by a previous request that was made to that entity. For example, a write request to the file system made by a database server 740 can be enabled by a query request made to the database. This notion is as follows.

The predicate triggers(C₁, O₁, A₁, E₁, C₂, O₂, A₂, E₂) is true if and only if one request—O₁,A₁ from C₁ to E₁—triggers a subsequent request—O₂,A₂ from E₁ (as client C₂) to E₂.

In the example above, the entity E₁ is the database server 740, E₂ is the file system, and C₂ is the userid of the database server 740 presented to the file system.

The predicate triggers*(C₁, O₁, A₁, E₁, Cₙ, Oₙ, Aₙ, Eₙ) is defined as the transitive closure of triggers. The intuition is that an operation invoked on E₁ can result in, via a series of intermediate invocations, the request Oₙ,Aₙ made by Cₙ to Eₙ.

The triggers predicate is used to analyze deny policies. For example, suppose it is desired to verify that there is no action that client C₁ can perform which eventually leads to operation Oₙ,Aₙ being performed on entity Eₙ. This can be verified by checking that triggers*(C₁, O₁, A₁, E₁, Cₙ, Oₙ, Aₙ, Eₙ) is not true for any choice of O₁, A₁, E₁, Cₙ. In practice, the closure represented as a propositional formula ranging over the variables O₁, A₁, E₁, C₁ is first computed and verified that this formula cannot be satisfied for the given client, and any choice of requests from that client.

The following is an example of a triggers rule which states the conditions under which a request from Apache to Tomcat is triggered by a request from a client to Apache.

triggers(client(machineID, IPaddr, credentials(user,password)),
get, url, apacheI, Me, TomcatI, jk2invoke, url)
:-
attr(ApacheI, runAs, Me)
isJSP(url)
attr(ApacheI, jspserver, TomcatI)

As before, it is noted that the predicate specifications form a datalog program. Therefore, the triggers predicate too can be efficiently computed. Furthermore, the closure of the predicate can be computed efficiently as well.

Next, consider the following sequence of events:
1. An employee, using a browser, requests a URL from Apache 720 and supplies his user name and password.
2. Apache 720, configured to do a basic authentication check, requests the auth_data file from the file system. This file contains the userid, password pairs used for basic authentication checks.
3. Having verified the client supplied password, Apache 720 requests the file corresponding to the URL from the file system.
   In this example, a client request triggered a read request by Apache 720 on the auth_data file. The read request for auth_data from Apache 720 to the file system, followed by the file sent back to Apache 720 is conceptually distinct from the client request to Apache 720, followed by Apache's request to the file system for the file corresponding to the URL. Therefore, in one embodiment, a flow label is inserted into each request by adding an extra flow label argument to the “allows” and triggers predicates. Thus, a model for Apache 720 can distinguish between the two flows by using a distinct flow label for the request for the auth_data file, and reusing the flow label on the incoming client request for the second request to the file system.

In this next section, sample fragments from models from Apache web server 720 and the Tomcat application container 730 are presented. Only one or two allows rules for each model are shown. A complete model for any one of these entities will contain several rules. A purpose here is to illustrate how the predicates from different models logically simulate the flow of information.

The first allows rule below corresponds to the following flow: if the URL requested corresponds to a jsp, and Apache 720 is configured to talk to a specific instance of Tomcat server 730, then the request succeeds if the Tomcat server 730 successfully processes the request from Apache (running as Apache user). The result returned by Tomcat 730 is passed back to the client:

allows(flabel, client(machineID, IPaddr, credentials(user,pwd)),
apacheI, get, url, Result)
:-
attr(ApacheI, runAs, Me)
isJSP(url)
attr(ApacheI, jspserver, TomcatI)
allows(flabel, Me, TomcatI, jk2invoke, url, Result)

The next rule corresponds to the following flow: if the client requests a file, and Apache 720 is configured to do a basic authentication check (check user password against auth_data file) then the request succeeds if the file system sends the auth_data file to Apache 720, the user password passes the authentication test, and the file system sends the requested file to Apache 720, which is returned to the client.

allows(flabel, client(machineID, IPaddr, credentials(user,pwd)),
apacheI, get, path, Result)
:-
authMethod(path) = basic,
allows(flabel2, apacheI, Filesys, read, Authfilename, auth_data)
authenticate(credentials, auth_data, OK)
allows(flabel, apache, Filesys, read, path, Result)

An operation requested by a client succeeds if Tomcat 730 is configured to translate the request into a command to a web application which, in turn processes the request and send the results back to Tomcat 730 which passes it back to the client.

allows(flabel, client, TomcatI, Op, Arg, Result) :-
isURL(Arg)
urlCommandMapping(Op, Arg, Application, Command, Args)
attr(TomcatI, runAs, TomcatUser)
allows(flabel, TomcatUser, Application, Command, Args, Result)

A request from a client to the web application succeeds if it translates into a db query that the web application sends to the db proxy it is configured to use, and the db proxy successfully processes the query and returns the results to the web app which passes it back to the client.

allows(flabel, client, WebAppI, Command, Args, Result) :-
attr(WebAppI, dbproxyconnection, dbC)
map(command, Args, Query, Args2)
allows(flabel, WebAppI, dbC, Query, Args2, Result)

### An Illustrative Validation Algorithm

With the terminology and semantics defined in the previous sections, an overview of the algorithm to validate access policies is presented for one embodiment. Details of all the steps are not provided. It is assumed that a datalog model is given for each entity type, and that for every entity instance, the input configuration data includes values for all attributes of the corresponding model.

Step 1. Attribute substitution. For every “allows” and “triggers rule,” replace all attribute names with the given configuration values.

Step 2. Datalog reduction. Reduce each rule for every entity instance to a boolean value or to a propositional formula over uninterpreted variables only.

One way to conceptualize this step is as follows. Each allows term unfolds as a tree, where each node corresponds to an allow rule, and its child nodes correspond to allows terms appearing in the body of the rule. As this tree is evaluated bottom-up, propositional formulas are combined at each node. These propositions are attribute-free, but may contain uninterpreted variables such as client information, or arguments of operations.

Step 3. Policy validation. Validate policies in order of decreasing priority as follows.
i. For each permit policy permit(C,E,S), check every allows rule of the form allows(E, C, O, A, R) for all O, A such that S=O×A and R is success. If at least one of these rules is true then the policy is upheld, else it is violated.
ii. For each deny policy deny(C,E,S), if (O,A)εS check if triggers*(C,*,*,*, *, O,A,E) is false for all choices of wildcards (*). If so, the deny policy is upheld. Otherwise it is violated.

Step 4. Verify least privilege holds. For every permit policy Permit(C,E,S) the set of allow predicates that must be true to uphold the policy consists of the allow terms in the subtree formed in Step 2 when an allows rule is unfolded. In this step, it is verified that any allows term that is true must support a permit policy, i.e., it must fall within one of these subtrees. If not, the default deny policy is violated.

### Expressions of Policies and Models

In one embodiment, enterprise access policies are defined using hierarchical definitions of roles, resources and services. This simplifies the problem of defining access policies across an enterprise. In addition to access policies, there are additional constraints on the assembly of the enterprise system that are captured. Assembly policies restrict the set of legal configurations that are allowed in the particular enterprise context. For example, requiring secure SSL (secure sockets layer) communications between two machines constrains how the two machines are configured. Another example of an assembly policy is that employees within the intranet can use login/password for authentication but employees on extranets must use SecureID. Such assembly policies can be captured as predicates on the configuration parameters of entities. Although the idea of using the logical power of datalog for modeling application behavior is important to guarantee efficient, and scalable, analysis, it is not required that future models be expressed in Prolog or that XSB Prolog be used as the underlying deduction engine. Indeed, in some embodiments, models are written in XML with a different lightweight deduction engine.

### Advantages and Benefits

As noted, administering information access can become very complicated in conventional systems. Several factors conspire to make this difficult:
1. Information flows are complex: roles and credentials can change in the middle of a chain of requests, so that the end application is unaware of the identity of the client who initiated the chain of requests. For example, a user can be denied access to query a database, but if the user is allowed to access a web application hosted on Tomcat 730, and the web application is allowed to query the database, then the user has a “backdoor” into the database. Each individual access is authorized, and therefore will not trigger an intrusion detection alarm, but the net effect violates the intent to block the user from accessing the database. Additionally, information flows can also fork into multiple flows.
2. A small configuration change in one component can have a significant impact on the set of possible information flows in the system. This is because the security properties are supported by the entire configuration as a whole. There are few, if any, tools to analyze the system-wide impact of a change. Penetration testing cannot uncover all possible security violations resulting from misconfigurations, only the ones known and tested for.
3. In large enterprises, the responsibility of administering networks, devices and applications is distributed across administrators in different organizations. Configuration changes are routine, and while change procedures may be documented and followed, these cannot always cover all system-wide effects.

In many cases, these procedures can be cumbersome, costly, and make the enterprise slow to adapt to changing business requirements. The net result is that, over time, a conventional system may allow undesirable information flows without anyone being aware of the possibility. With embodiments of the present disclosure, however, a vulnerability may be detected before the vulnerability is actively exploited.

Advantageously, one embodiment of the enterprise environment analysis system 100 provides an analysis approach that does not put any significant additional load on the network either in terms of traffic such as probes or in terms of processing such as online traffic analysis. Rather, the enterprise environment analysis system 100 depends on data that is already being collected for management.

Further, the analysis connects the composite security properties of the environment directly to highlevel policies without human intervention or interpretation necessary. This allows the creation of one view of the entire enterprise that shows the policies that are being upheld or violated, how each violation can achieved, and what path each legitimate service is taking. This eliminates the need for an administrator to be expert in multiple technologies/interfaces.

Further, the analysis finds both positive and negative failures. All legitimate services that are blocked are computed as well as service access that is beyond what policy allows.

The analysis finds all possible service access both direct and indirect. Thus if a service can be a chain of components that was not foreseen by the designer, the analysis will reveal this. The analysis supports meta-policies such as default-deny wherein every access that is not explicitly or implicitly permitted is detected and flagged. This supports the principle of “least privilege” which states that the access level should be exactly what is necessary, nothing less or more.

Advantageously, models are universal. That is, all components can be modeled in a uniform manner prescribed. The models can be composed together. Thereby, the composite effect of multiple components interacting with each other may be automatically computed. While various methods have been proposed for doing a priori analysis of environments, these conventional methods are restricted to either the network layer alone or only analysis of vulnerabilities or only addressing specific classes of attacks (e.g. privilege escalation). These methods do not propose any universal modeling methodology or policy framework, as featured in embodiments of the enterprise environment analysis system 100.

Models use configuration data that is extracted directly from the environment, so no additional steps are needed to transform the description of the environment into usable data. Furthermore, the approach allows the actual component interactions as present in the actual environment to be analyzed.

Advantageously, policies, represented as accessibility of services to roles, while unique are a natural fit for describing high-level intent in enterprise-scale security policy. The policy language is simple enough to be stateable by non-expert human administrators and yet precise enough to be automated for enforcement and maintenance. This eliminates/greatly reduces the need for expert human supervision.

The policies uniquely capture both positive (services that should be accessible) and negative (services that should not be accessible) requirements together. Unlike other works, this approach guarantees that legitimate access will not be affected while blocking illegitimate access.

Advantageously, the validation engine calculates the net behavior of the system with respect to security properties, not just the individual behaviors of the components. The analysis can thus catch security gaps that are created by the interaction of components that may not be evident at the individual component level.

The analysis is deterministic, not statistical. Thus, the modeler is not required to assign probabilities to events which is very hard to do in practice. Attack paths that hide within normal usage patterns can be found, which would be something that is hard to catch with a conventional statistical analysis tool. At the same time, an unusual path that does not cause a violation can be correctly validated, which would be hard for conventional anomaly detectors to do.

The approach can compute the impact of any configuration setting to the security policy of the enterprise a priori (i.e. without deploying the change). Any violations that are likely to arise in the real environment of the combination of configurations and policies is deployed will be detected by the impact analysis. This means that with sufficient care administrators can push changes into the enterprise knowing that the changes will not cause any violations of policy. This impact analysis is rigorous and is guaranteed to be complete. This can also be used as a “sensitivity” analysis—by changing configurations for a fixed policy (and vice-versa), the user of the tool can learn which configurations afford degrees of freedom without creating policy violations.

Advantageously, the approach can compute all the services that would be available at any point in any given enterprise network. This would be invaluable to administrators who are trouble-shooting the network or want to know why some service is not accessible to a client. Similarly, all the clients that can access a given service can be computed along with which paths. The user can test the effectiveness of individual Access Control List (ACL) members so that ineffective rules can be eliminated and the lists optimized. This is valuable because ACLs become unmanageably long and unwieldy over time in enterprise.

Given an enterprise with configured components and a set of enterprise-wide high-level access policies, the enterprise environment analysis system 100 can continuously test whether the enterprise is in compliance with security policies. This gives a unique “closed-loop” solution for enterprise security based on high-level policy that requires little or no human supervision. Thus enterprise environments can be made self-adaptive to operator errors, attacks, and vulnerability alerts.

Whenever the enterprise environment is not in compliance, the enterprise environment analysis system 100 can generate new configurations for components that will bring the system back into compliance. Multiple compliant solutions that an administrator can choose between can also be generated.

Advantageously, the enterprise environment analysis system 100 can use operational heuristics to automatically weight or choose the best option among these. The enterprise environment analysis system 100 can automate the system change to the new configuration so that the environment can defend itself against both operator error, as well as configuration change due to an attack. The defense is intelligent in that the system does not merely attempt to roll the state of the environment back to a previous state but can choose between multiple states that are all compliant. This is useful for automatic defense even in the case of failure of one or more components in which case roll back to a previous may not be possible. The generated configurations are guaranteed to be policy compliant. Thus the current problem that administrators face which is the possibility of violating one policy in the process of complying with another is solved.

Advantageously, the approach can automate defense-in-depth. The enterprise environment analysis system 100 can automatically validate/reconfigure so that every service access that is supposed to be blocked is blocked by at least k different access control mechanisms across one or more components where k is a parameter fixed by the user.

Since an important problem in security management is managing vulnerability alerts and hardware and software upgrades or version changes, this approach gives a unique advantage in that the enterprise environment analysis system 100 can assess whether a new vulnerability can cause a new policy violation. Thus administrators can thus safely ignore vulnerabilities that do not violate policies if they so choose. Similarly they can verify whether a hardware or software change can cause policy violations in the enterprise before they are deployed to maintain the security of the enterprise.

Accordingly, the enterprise environment analysis system 100 provides a tool for an administrator to try out various settings safely and choose one that is guaranteed to be compliant with security policy. This tool can accurately compute all the services available to that client by looking at the configurational settings alone in any given enterprise setting. In so doing, configurations that are guaranteed to comply with security policy for any given enterprise setting can be provided automatically.

As such, a systematic framework is provided, which, given the security configurations of hosts, applications and network infrastructure, automatically verifies whether the enterprise is in compliance with organizational access policy. The framework is built on a rigorous foundation, with a provably efficient method for verifying organizational access policy.

### A Computer Embodiment

FIG. 7 illustrates an example computer system 700 used in conjunction with certain embodiments of the disclosure. As illustrated in FIG. 7, computer system 700 comprises processor(s) 702. The computer system 700 also includes a memory unit 730, local interface 722, and Input/Output (I/O) devices 724. The processor(s) 702, memory unit 730, and I/O devices 724 are coupled to a local interface 722. The local interface 722 can be, for example but not limited to, one or more buses or other wired or wireless connections, as is known in the art. The processor(s) 702 may comprise any suitable processor architecture. The computer system 700 may comprise one, two, three, or more processors, any of which may execute a set of instructions in accordance with embodiments of the present disclosure.

The software in memory 730 may include one or more separate programs, each of which comprises an ordered listing of executable instructions for implementing logical functions. In the example of FIG. 7, the software in the memory 730 includes the validation engine 110 in accordance with the present disclosure and a suitable operating system (O/S) 740. Logic of the validation engine 110 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The scope of the present disclosure includes embodying the functionality of the preferred embodiments of the present disclosure in logic embodied in hardware or software-configured mediums.

Any process descriptions or blocks in flow charts should be understood as representing modules, segments, or portions of code which include one or more executable instructions for implementing specific logical functions or steps in the process, and alternate implementations are included within the scope of one embodiment in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure.

Therefore, having thus described the invention, at least the following is claimed:

1. A system for analyzing an enterprise environment, comprising:
a modeling module that determines possible accesses to enterprise network services from a plurality of entities; and
a validation module that determines whether a possible access to an enterprise service by a particular entity violates an enterprise policy, the enterprise policy governing which entities are authorized to access one or more enterprise services.

2. The system of claim 1, wherein the modeling module determines the possible accesses by considering configuration parameters of enterprise environment components.

3. The system of claim 1, wherein the validation module compares the possible accesses against a set of enterprise policies, wherein the set of enterprise policies are positive and negative requirements for accessibility of services to enterprise entities.

4. The system of claim 1, wherein the validation module reports policy violations to a system administrator.

5. The system of claim 1, wherein the validation module computes configuration changes to restore compliance with an enterprise policy after violations are determined.

6. The system of claim 5, wherein the validation module automatically changes the enterprise environment in accordance with the computer configuration changes.

7. The system of claim 1, wherein the modeling module accepts input of configuration values and changes in existing configuration settings and enterprise policies such that the validation module determines whether current settings uphold current enterprise policies.

8. The system of claim 1, wherein the validation module computes all the possible access paths that enterprise policy allows and blocks.

9. The system of claim 1, wherein the validation module is configured to provide a choice of multiple compliant solutions to an administrator.

10. The system of claim 1, wherein the validation module is configured to compute an impact of any change in a configuration setting to an enterprise policy without deploying the change.

11. A method for analyzing an enterprise environment, comprising the steps of:
collecting configuration data from a collection of enterprise network components that characterize the enterprise environment;
binding the configuration data of each enterprise network component to a model of that component; and
computing a set of all possible accesses to the network components in the enterprise environment based on the configuration data and models.

12. The method of claim 11, further comprising the steps of:
comparing the accesses to a stated enterprise policy, the enterprise policy governing which entities are authorized to access one or more enterprise network components; and
generating a report that describes if the enterprise environment is in compliance with the stated enterprise policy.

13. The method of claim 11, further comprising the step of:
generating new configurations to one or more network components that will return the enterprise environment to compliance.

14. The method of claim 13, further comprising the step of:
pushing new configuration data out to the network components to achieve compliance.

15. The method of claim 14, further comprising the step of:
after the pushing step, collecting configuration data again to confirm enterprise policy compliance.

16. The method of claim 15, further comprising the step of:
if compliance is not confirmed, repeating the process of collecting configuration data and generating new configuration settings in an attempt to achieve compliance.

17. The method of claim 11, further comprising the step of:
accepting data describing a vulnerability in an existing network component.

18. The method of claim 17, wherein the computing step also considers vulnerability data in computing the possible accesses.

19. The method of claim 17, further comprising the step of:
reporting whether violations are caused by the vulnerability.

20. A computer readable medium having a computer program for analyzing an enterprise environment, the program having instructions for performing the steps of:
collecting configuration data from a collection of enterprise network components that characterize the enterprise environment;
binding the configuration data of each enterprise network component to a model of that component; and
computing a set of all possible accesses to network components in the enterprise environment based on the configuration data and models.

21. The computer readable medium of claim 20, the program further performing the steps of:
comparing the accesses to a stated enterprise policy, the enterprise policy governing which entities are authorized to access one or more enterprise network components; and
generating a report that describes if the enterprise environment is in compliance with the stated enterprise policy.

22. The computer readable medium of claim 20, the program further performing the steps of:
generating new configurations to one or more network components that will return the enterprise environment to compliance.

23. The computer readable medium of claim 22, the program further performing the step of:
pushing new configuration data out to the network components to achieve compliance.

24. The computer readable medium of claim 23, the program further performing the step of:
after the pushing step, collecting configuration data again to confirm enterprise policy compliance.

25. The computer readable medium of claim 24, the program further performing the step of:
if compliance is not confirmed, repeating the process of collecting configuration data and generating new configuration settings in an attempt to achieve compliance.

26. The computer readable medium of claim 20, the program further performing the step of:
accepting data describing a vulnerability in an existing network component.

27. The computer readable medium of claim 26, wherein the computing step also considers vulnerability data in computing the possible accesses.

28. The computer readable medium of claim 26, the program further performing the step of:
reporting whether violations are caused by the vulnerability.

29. A method for analyzing a proposed enterprise environment, comprising the steps of:
receiving a list of network components that are included in the proposed enterprise environment;
receiving configuration values for the network components;
receiving a set of enterprise policies that govern which entities are authorized to access the network components;
detecting if the configuration values of the network components allow an enterprise policy to be violated; and
providing an example violation that may occur if an enterprise policy violation has been detected.

30. The method of claim 29, further comprising:
changing at least one configuration setting after detection of the enterprise policy violation; and
determining if the change brings the proposed enterprise environment in compliance with the set of enterprise policies.

31. The method of claim 29, further comprising:
changing at least one enterprise policy after detection of the enterprise policy violation; and
determining if the change brings the current configuration settings in compliance with the new set of enterprise policies.

32. A system for analyzing an enterprise environment, comprising:
means for determining possible accesses to enterprise network services from a plurality of entities; and
means for determining whether a possible access to an enterprise service by a particular entity violates an enterprise policy, the enterprise policy governing which entities are authorized to access one or more enterprise services.

33. The system of claim 32, wherein the possible accesses are determined by considering configuration parameters of enterprise environment components.

34. The system of claim 32, wherein the possible accesses are compared against a set of enterprise policies, wherein the set of enterprise policies are positive and negative requirements for accessibility of services to enterprise entities.

35. The system of claim 32, wherein policy violations are reported to a system administrator.

36. The system of claim 32, wherein configuration changes are computed to restore compliance with an enterprise policy after violations are determined.

37. The system of claim 32, wherein the enterprise environment is automatically changed in accordance with the computer configuration changes.

38. The system of claim 32, wherein input of configuration values and changes in existing configuration settings and enterprise policies are accepted and sued to determine whether current settings uphold current enterprise policies.

39. The system of claim 32, wherein all possible access paths that enterprise policy allows and blocks are computed.

40. The system of claim 32, wherein a choice of multiple compliant solutions is provided to an administrator.

41. The system of claim 32, wherein an impact of any change in a configuration setting to an enterprise policy without deploying the change is computed.
